(19) United States
(12) Patent Application Publication
(10) Pub. No.: US 2011/0252449 A1
(43) Pub. Date: Oct. 13, 2011

(54) PROGRAM CONTENT VIEW SYSTEM AND CONTENT RECEPTION RECORD REPRODUCTION DEVICE

(76) Inventors: Takumi Akiyama, Tokyo (JP); Makoto Donoura, Tokyo (JP); Shigeru Imai, Tokyo (JP); Hiroki Sakaguchi, Tokyo (JP); Takehiko Hanada, Tokyo (JP); Shin Miura, Tokyo (JP); Junichi Yokosato, Tokyo (JP)

(21) Appl. No.: 13/140,511

(22) PCT Filed: Dec. 4, 2009
(86) PCT No.: PCT/JP2009/006631

§ 371 Date: Jun. 17, 2011

(30) Foreign Application Priority Data
Dec. 26, 2008 (JP) 2008332953

(51) Int. Cl. H04N 5/445

(52) U.S. Cl. 725/50

(57) ABSTRACT

Upon reception selecting a program to be viewed, upon recording a received program, and upon reproducing a recorded program, as well as at the end of each operation thereof, a master creates viewing information including a corresponding program name, a transmission station name, and a name of a current operating mode thereof, and transmits the created viewing information to the slave via the viewing information management server, and when an option for “viewing an identical program to the master” provided in an input unit for selecting the program to be viewed is selected, a slave receives and displays or receives and records a program having an identical station name to a program that is currently being received and displayed or received and recorded in the master, on the basis of the latest viewing information of the master received from the viewing information management server.

### TECHNICAL FIELD

The present invention relates to a program contents viewing system in which an identical program is individually obtained by two apparatuses but is simultaneously subjected to an identical operation in the two apparatuses, and a contents reception record reproduction apparatus (device) for use in the system.

### BACKGROUND ART

In a conventional apparatus for viewing contents, a method is examined in which contents having an identical title (or program) can be viewed simultaneously on a plurality of apparatuses linked via a network. In a conventional technique, a plurality of apparatuses transmit and receive lists of contents respectively recorded thereon via a network. The two lists are then compared and shared contents is synchronized, whereupon communication is performed with a partner while viewing recorded contents having an identical title on respective displays (see Patent Document 1, for example). According to this technique, the contents itself does not pass through the network, and therefore identically titled contents can be viewed without transmission line limitations. Furthermore, in this case, the contents is not copied, and therefore copyrighted contents can be viewed without problems.

In another conventional technique relating to a contents viewing apparatus in which contents can be viewed at an arbitrary viewpoint or a plurality of viewpoints, settings such as viewpoint are synchronized between a plurality of apparatuses on a network (see Patent Document 2, for example). In this technique, a plurality of users can view identical contents at an identical setting such that a viewpoint operation, zapping, and so on to another apparatuses over a network are transmitted and synchronized. Further, to prevent the occurrence of dissatisfaction among the users, a synchronization subject can be determined through negotiation or in sequence.

### PRIOR ART DOCUMENTS

### Patent Documents

Patent Document 1: Japanese Patent Application Publication No. 2007-159098

Patent Document 2: Japanese Patent Application Publication No. 2006-005415

### SUMMARY OF THE INVENTION

In the technique according to Patent Document 1 as described above, the contents of an identical program recorded on each of apparatuses is viewed, and therefore two users are required to perform a recording operation. Further, the users must agree to view the contents, and it is therefore not easy to view identical programs. Moreover, identical programs can only be viewed at the very time agreed by the two users.

On the other hand, in the technique according to Patent Document 2, a user must perform operations to select a setting synchronization partner and a manner in which the settings are to be synchronized; thus, there is a problem such that viewing conveniently an identical program is not possible. Further, there is a limitation that only when a first user is viewing a program, it is possible for a second user to view the same program.

The present invention has been designed to solve the problems described above, and an object of the invention is to provide a program contents viewing system and a contents reception record reproduction apparatus such that an identical program to a program viewed by a certain user can be received by another user through a simple operation and viewed at the same time.

In a program contents viewing system according to the present invention, at least two contents reception record reproduction apparatuses having a function for receiving and displaying, receiving and recording, and reproducing a program obtained from a broadcast or a network distribution service are connected to and registered in a viewing information management server as a master and a slave via a network; upon reception selecting a program to be viewed, upon recording a received program, and upon reproducing a recorded program, as well as at the end of each operation thereof, the master creates viewing information including a corresponding program name, a transmission station name, and a name of a current operating mode thereof, and transmits the created viewing information to the slave via the viewing information management server; and when an option for “viewing an identical program to the master” provided in an input unit for selecting the program to be viewed is selected, the slave receives and displays or receives and records a program having an identical station name to a program that is currently being received and displayed or received and recorded in the master, on the basis of the latest viewing information of the master received from the viewing information management server.

According to the present invention, a user of the master can view a broadcast or distributed program, or a recorded program by performing a typical operation for selecting a program or recording and reproducing a program, while a user of the slave can view the same received program or recorded program as the user of the master easily without performing any special operations other than selecting the option for selecting the program to be viewed.

### BRIEF DESCRIPTION OF THE DRAWINGS

FIG. 1 is a block diagram showing a system configuration in which a plurality of contents reception record reproduction apparatuses are connected to a network in a first embodiment of the present invention;

FIG. 2 is an illustrative view showing an example of a data configuration of viewing information in accordance with the first embodiment;

FIG. 3 is a flowchart showing viewing information transmission processing in a master in accordance with the first embodiment;

FIG. 4 is a flowchart showing viewing processing performed in a slave in relation to “viewing” in the master in accordance with the first embodiment;

FIG. 5 is a flowchart showing recorded program reproduction processing performed in the slave in relation to “recorded program reproduction” in the master in accordance with the first embodiment;

FIG. 6 is a flowchart showing recorded program reproduction processing performed in the slave when “recorded program reproduction ended” is already established in the master in accordance with the first embodiment;

FIG. 7 is a flowchart showing processing in which the slave records a program currently “recording” in the master in accordance with the first embodiment;

FIG. 8 is a flowchart showing timer recording processing performed in the slave in relation to a program that is currently under view and record in the master in accordance with the first embodiment;

FIG. 9 is an illustrative view showing an example of a data configuration of viewing information in accordance with a second embodiment of the present invention;

FIG. 10 is a flowchart showing viewing information transmission processing performed in a master in accordance with the second embodiment; and

FIG. 11 is a flowchart showing recorded program reproduction processing performed in a slave in response to “recorded program reproduction” in the master in accordance with the second embodiment.

### BEST MODE FOR CARRYING OUT THE INVENTION

In the following, in order to describe the present invention in further detail, embodiments of the present invention will be described below with reference to the attached drawings.

### First Embodiment

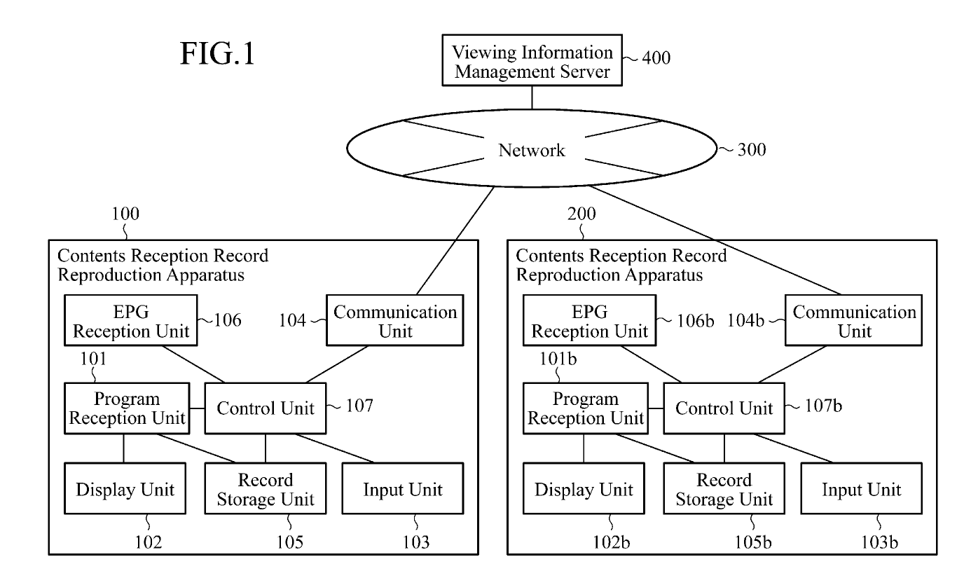

FIG. 1 is a block diagram showing the constitution of a program contents viewing system in accordance with a first embodiment of the present invention.

In the drawing, two contents reception record reproduction apparatuses 100, 200 are connected to a viewing information management server 400 via a network 300. The contents reception record reproduction apparatuses 100, 200 have basically identical functional constitutions, and therefore the constitution of the contents reception record reproduction apparatus 100 will be described. Note that in the first embodiment a program from a broadcast wave will be described as a target.

The contents reception record reproduction apparatus 100 includes a program reception unit 101 for receiving a broadcast wave, a display unit 102 constituted by liquid crystal or the like, for example, for displaying program contents, an input unit 103 for selecting a viewing program to be displayed on the display unit 102 through a user operation, a communication unit 104 for communicating with another apparatus via the network 300, a record storage unit 105 for recording and storing (recording, hereafter) program contents included in the broadcast wave, an EPG (Electronic Program Guide) reception unit 106 for receiving EPG information, and a control unit 107 for controlling the above units in a manner described below.

Note that in a case where the apparatus 100 is used as a slave described below, the input unit 103 for selecting a program to be viewed is assumed to include a selection function for “viewing an identical program to a master (corresponding to the partner apparatus 200 in this case)” in addition to a broadcast wave program (this selection will be referred to hereafter as an “option”).

Further, the record storage unit 105 has a recording function that includes a function for recording a program currently under broadcast, a function for setting a timer to record a program that will be scheduled for broadcast in the future, and a timer recording function for recording a program automatically in accordance with a control described below, these functions being activated in response to instructions from the user.

Hereupon, the contents reception record reproduction apparatuses 100, 200 have identification information such as IDs and verification information such as passwords, which are associated with the apparatuses themselves. The viewing information management server (to be referred to hereafter as a server) 400 registers and holds the identification information and verification information of the contents reception record reproduction apparatuses 100, 200. Further, the contents reception record reproduction apparatuses 100, 200 are connected to the network 300 in association with each other: one serves as a master, while the other serves as a slave. Therefore, the server 400 also registers and holds setting information associating the contents reception record reproduction apparatuses 100, 200 with each other as the master and the slave.

In the following descriptions, the contents reception record reproduction apparatus 100 is the master, while the contents reception record reproduction apparatus 200 is the slave. However, since the two apparatuses are constituted identically, the roles of the two apparatuses may be reversed by setting the master/slave relationship oppositely. Note that since the master 100 and the slave 200 are constituted identically, “b” will be affixed to reference numerals for the respective parts of the master 100 to indicate corresponding parts of the slave 200.

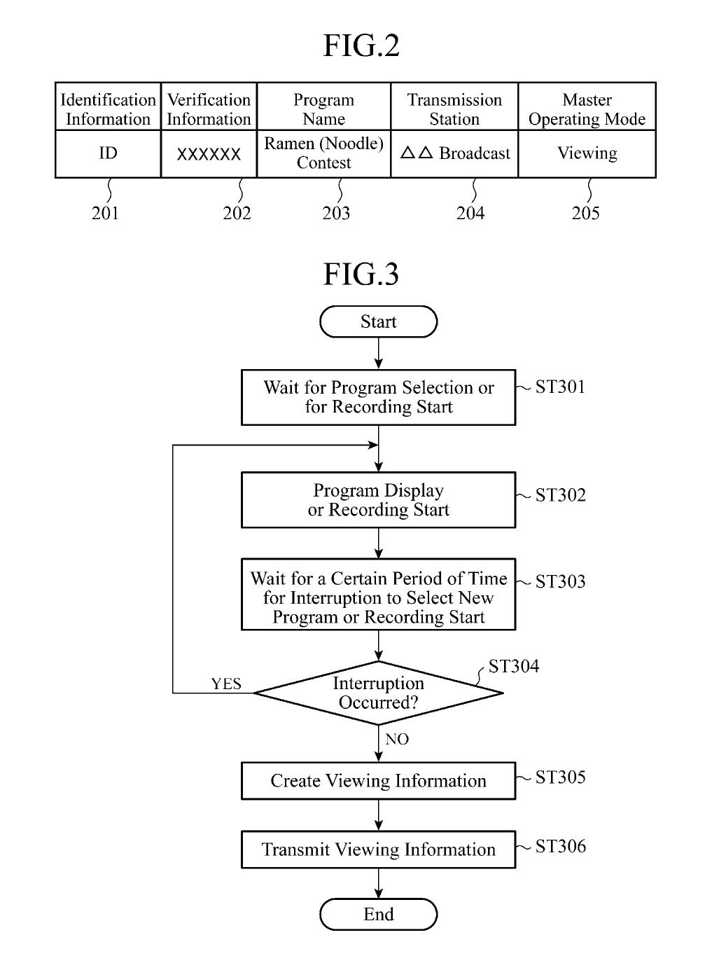

Viewing information transmitted to the server 400 by the master 100 is created by the control unit 107 and has a data configuration as illustrated in FIG. 2, for example. In FIG. 2, 201 is an ID serving as the identification information of the master, 202 is a password serving as the verification information of the master, 203 is a name of a program currently under reception to be obtained from the EPG information, 204 is a name of a transmission station (a broadcast station, a distribution station, a channel number, or the like) of the program 203 to be obtained from the EPG information, and 205 is a name of an operating mode indicating a current usage condition of the program in the master. The operating mode name 205 may be described by any one of “viewing”, indicating that the received program is currently under display in the display unit 102, “viewing ended”, indicating that viewing is ended, “recording”, indicating that the received program is being recorded to the record storage unit 105, “recording ended”, indicating that recording is ended, “recorded program reproduction”, indicating that a recorded program is being reproduced, “recorded program reproduction ended”, indicating that reproduction of the recorded program is ended, and so on.

First, an operation of the master 100 will be described.

When a user of the master uses the input unit 103 to select a program to be viewed from currently broadcast programs, the control unit 107 controls the program reception unit 101 to receive the selected program, whereupon the contents of the received program is displayed by the display unit 102. Further, when the program selected by the user is displayed, the control unit 107 transmits viewing information to the server 400 via the communication unit 104. Note that the viewing information is also transmitted when the operating mode of the master is modified, including a case where the user of the master performs recording using the record storage unit 105, a case where a recording begins as a set time for starting a timer recording arrives, and so on.

Viewing information transmission processing performed by the control unit 107 will now be described with reference to a flowchart shown in FIG. 3.

First, a standby state is maintained for program selection or recording start (step ST301). When the program selection or the recording start arises, a selected program is displayed or the recording thereof is started (step ST302). Thereafter, a standby state is maintained for a certain period of time while waiting for an interruption of a new program selection or record start (step ST303). This operation is performed to prevent the viewing information from being transmitted frequently within a short time period; the waiting is preferably several seconds or so, but in some cases, subsequent processing may be performed immediately without waiting. If the interruption of the new program selection or record start arises within a certain period of time, the routine returns to step ST302, and when the interruption does not arises, the routine advances to the following step ST305 (step ST304).

In step ST305, the control unit 107 creates viewing information relating to the program selected by the user or the program for which recording has begun. Next, the created viewing information is transmitted to the server 400 using the communication unit 104 (step ST306). In this case, the identification information (ID or the like) and verification information (password or the like) associated with the master 100 itself is described in the viewing information and transmitted therewith so that the server 400 can identify the master 100 and verify that the viewing information is provided from the master 100 as illustrated in FIG. 2.

When receiving the viewing information, the server 400 identifies and verifies the master 100 from the identification information and verification information and then stores the received viewing information. The server 400 either receives a periodical inquiry from the slave 200 or transmits the stored viewing information to an open port of the slave 200.

When the user eventually finishes viewing the program (i.e. switches the apparatus OFF or the like) or when the recording is ended (when the broadcast of the timer recorded program is ended and so on), the master 100 transmits viewing information in which “viewing ended” or “recording ended” is set (described in code) as the operating mode name.

Next, an operation of the slave 200 will be described.

First, when a user of the slave selects a desired currently broadcast program using the input unit 103b, the control unit 107b controls the program reception unit 101b to receive the selected program, whereupon the contents of the received program is displayed by the display unit 102b. Further, the control unit 107b transmits the identification information and verification information owned by the slave 200 associated with the slave 200 to the server 400 via the communication unit 104b so that the server 400 can identify and verify the slave. The slave 200 then receives the viewing information from the master 100 via the server 400. Note that the slave 200 can receive the viewing information by issuing an inquiry to the server 400 periodically at short intervals or by opening a port so that notifications from the server 400 can be received at all times.

By using the input unit 103b, the user of the slave 200 can select an option for “viewing an identical program to the master” as well as selecting a normal broadcast program.

Hereupon, the slave 200 may exist at a geographically far from the master 100; in such a case, programs broadcast in the existing area of the slave 200 may not always be identical to the programs broadcast in the existing area of the master 100. Further, an identical program may be broadcast in a different area a week later or the like, and it is possible to determine whether or not a program is to be scheduled for broadcast in the future by the EPG. Hence, a program is determined to be identical when it has an identical program name in the EPG.

When the user of the slave 200 selects the option using the input unit 103b, the control unit 107b of the slave 200 retrieves/determines viewable programs in sequence on the basis of the latest viewing information from the master 100 and the name of the program currently under view by the user on the slave 200, in the following order of precedence, for example and displays the retrieved/determined programs on the display unit 102b.

### Displayable Order of Precedence:

(1) A program currently displayed on the master;

(2) A recorded program currently under reproduction by the master; and

(3) A recorded program already reproduced on the master and viewed by the user of the master.

This retrieval/determination operation is performed every time the user selects the option, every time the viewing information of the master 100 is updated, and every time the broadcast of a program is ended; as a result, the displayed programs are updated. Where there is no program that meets any of the above categories, nothing is displayed.

Next, the manner in which the programs described in the above order of precedence are retrieved and the manner in which the display ability thereof is determined will be described with reference to each item in the order of precedence.

(1) A program currently under view on the master 100 can be displayed when the operating mode name in the viewing information is “viewing” and an identical program is currently under broadcast in the existing area of the slave 200. The determination as to whether or not an identical program is currently being broadcast in the existing area of the slave 200 is made by retrieving the program name from the EPG information received by the EPG reception unit 106b.

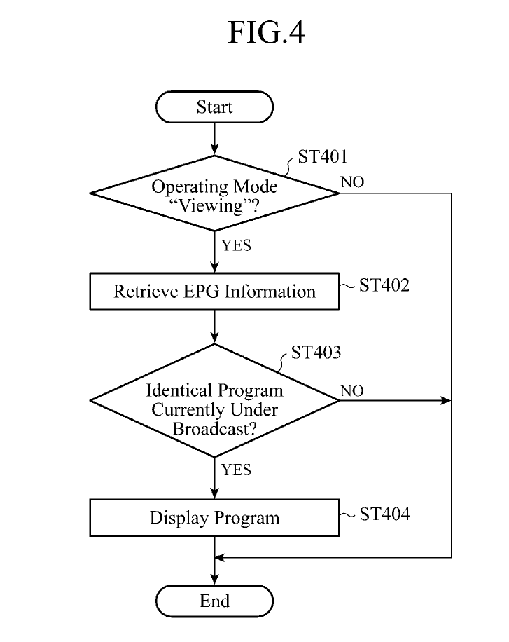

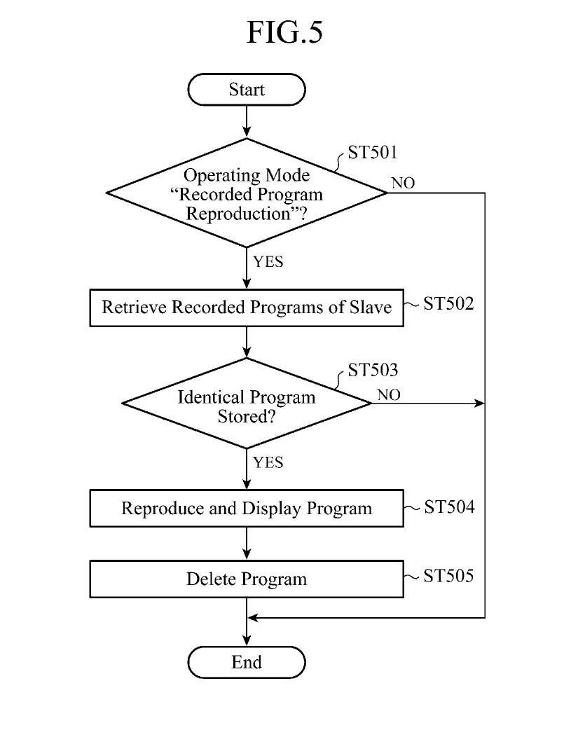

A processing flow of the control unit 107b at this time will now be described in accordance with FIG. 4. First, a determination is made as to whether or not the operating mode in the latest viewing information received from the master 100 is “viewing” (step ST401). When the mode is “viewing”, the program name included in the viewing information is retrieved from the EPG information received by the EPG reception unit 106b (step ST402). When an identical program is currently under broadcast (step ST403), the contents of the program is received and displayed on the display unit 102b (step ST404). Note that when the operating mode name is not “viewing” in step ST401 or when an identical program is not currently under broadcast in step ST403, the routine is terminated without displaying anything.

(2) A recorded program currently under reproduction in the master 100 can be displayed when the operating mode name in the viewing information is “recorded program reproduction” and an identical program has already been recorded by the recording function of the slave 200.

A processing flow executed by the control unit 107b at this time will now be described in accordance with FIG. 5. First, a determination is made as to whether or not the operating mode in the latest viewing information from the master 100 is “recorded program reproduction” (step ST501). When the operating mode name is “recorded program reproduction”, a determination is made as to whether or not a program having an identical program name in the recorded program reception information in the slave 200 can be retrieved from the record storage unit 105b (step ST502). When an identical program is stored in the record storage unit 105b (step ST503), the recorded contents of the program is reproduced and displayed on the display unit 102b (step ST504). Thereafter, the program is deleted to avoid an event such that the same program is displayed a plurality of times (step ST505). Note that when the operating mode name is not “recorded program reproduction” in step ST501 or when the same program is not stored in step ST503, the routine is terminated without performing reproduction and display.

(3) A recorded program already reproduced on the master and viewed by the user of the master can be displayed when a program that has been recorded by the recording function of the slave 200 exists, an identical program name exists in the viewing information received from the master 100 in the past, and the viewing information in which the operating mode name is “recorded program reproduction” has been received in the past.

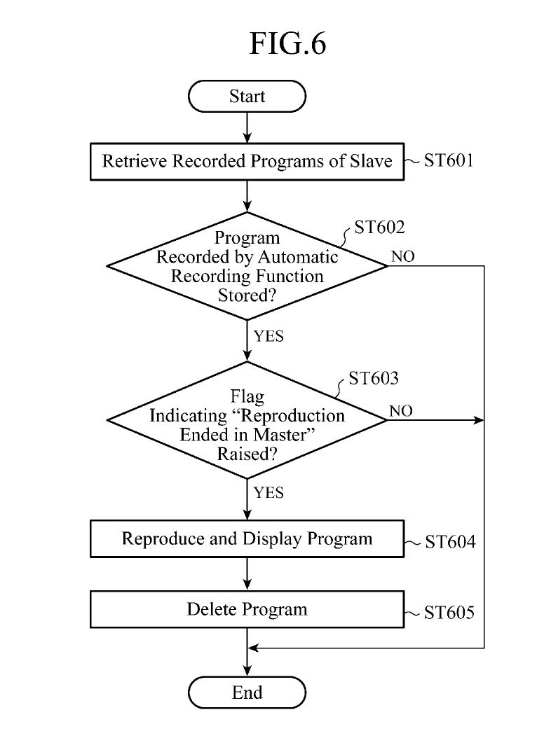

A processing flow executed by the control unit 107b at this time will now be described in accordance with FIG. 6. First, the control unit 107b retrieves a program recorded by an automatic recording function described below from the programs recorded in the record storage unit 105b (step ST601). When a program recorded by the automatic recording function is stored (step ST602), a determination is made as to whether or not a flag indicating “reproduction ended in master” described below has been raised in relation to this program (step ST603). When the flag is raised, the contents of the recorded program is reproduced and displayed on the display unit 102b (step ST604). Thereafter, the program is deleted to avoid an event such that the same program is displayed a plurality of times (step ST605). Note that when a program that has been recorded by the automatic recording function does not exist in step ST602 or the flag indicating “reproduction ended in master” is not raised in step ST603, the routine is terminated without performing reproduction and display.

In order to ensure that the recorded program reproduction processing can be performed in relation to items (2) and (3) in the above order of precedence, the following processing relating to recording is performed in advance in the slave 200.

On the basis of the latest viewing information from the master 100 and the name of the program currently under view on the slave 200, the control unit 107b retrieves a program having the highest order of precedence from among recordable programs in accordance with the order of precedence of the following list, for example, and controls the record storage unit 105b to record the retrieved program.

### Recordable Order of Precedence:

1) A program for which recording has been instructed by the user of the slave;

2) A program currently under record in the master; and

3) A timer recorded program recorded by automatic timer recording control, to be described below

This retrieval/determination operation is performed every time the viewing information of the master 100 is updated, every time the program under view on the slave 200 is changed, and every time the recording of a single program is ended, and as a result, the recorded program is changed. Where there is no program that meets any of the above categories, nothing is displayed.

Next, the manner in which the programs specified in this order of precedence are retrieved/determined will be described with reference to each item in the order of precedence.

1) A program for which recording has been instructed by the user of the slave can be recorded when the record storage unit 105b receives an instruction from the user indicating that a program currently under broadcast is to be recorded or when an instruction to set a timer to record a program to be scheduled for broadcast in the future is received in the past and the corresponding program is currently under broadcast.

2) A program currently under record in the master 100 can be recorded when the operating mode name in the viewing information is “recording” and an identical program is currently under broadcast in the existing area of the slave 200. The determination as to whether or not an identical program is currently under broadcast in the existing area of the slave 200 is made by retrieving the program name from the EPG information received by the EPG reception unit 106b.

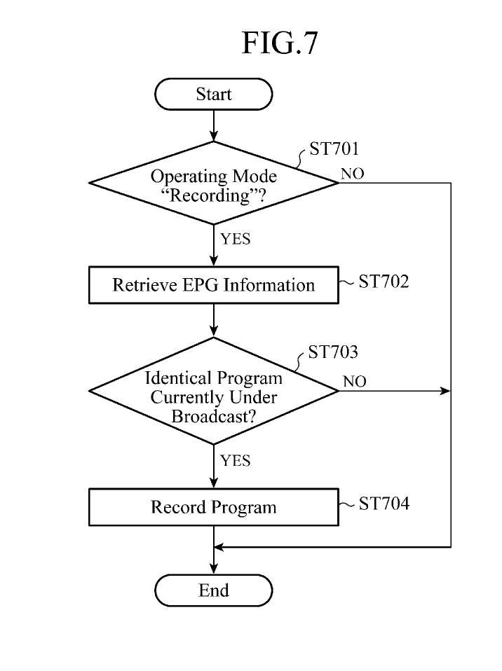

A processing flow executed by the control unit 107b at this time will now be described in accordance with FIG. 7. First, a determination is made as to whether or not the operating mode name in the latest viewing information received from the master 100 is “recording” (step ST701). When the operating mode name is “recording”, the program name included in the viewing information is retrieved from the EPG information received by the EPG reception unit 106b (step ST702). When an identical program is currently under broadcast (step ST703), the program is recorded by the record storage unit 105b (step ST704). Note that when the operating mode name is not “recording” in step ST701 or when an identical program is not currently under broadcast in step ST703, the routine is terminated without recording anything.

3) A timer recorded program recorded by an automatic timer recording control can be recorded when a program subjected to timer recording in accordance with a control described below is currently under broadcast. In the automatic timer recording control, a program currently under view and record on the master 100 is not currently under broadcast in the existing area of the slave 200, but when it is determined from the EPG information received by the EPG reception unit 106b that the program is to be scheduled for broadcast in the future, a timer is set to record the program automatically.

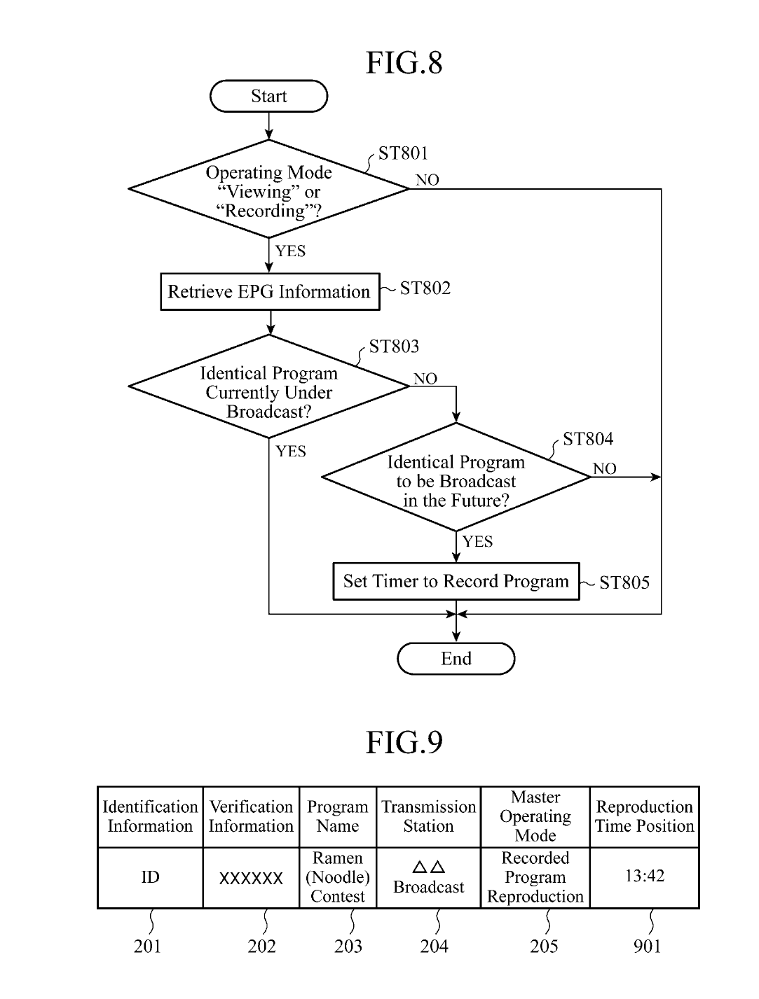

The timer recording control executed by the control unit 107b at this time will now be described in accordance with FIG. 8. First, a determination is made as to whether or not the operating mode name in the latest viewing information from the master 100 is “viewing” or “recording” (step ST801). When the operating mode name is “viewing” or “recording”, the program name included in the viewing information is retrieved from the EPG information received by the EPG reception unit 106b (step ST802). When an identical program is not currently under broadcast in the existing area of the slave 200 (step ST803) but will be broadcast in the future (step ST804), the record storage unit 105b is set a timer to record the program (step ST805). Note that when the operating mode name is neither “viewing” nor “recording” in step ST801, when an identical program is currently under broadcast in the existing area of the slave 200 in step ST803, or when an identical program will not be broadcast in the future in step ST804, the routine is terminated without performing timer recording.

When the program recorded through the control described above has an identical name to the program name included in the viewing information from the master 100 and the operating mode name is “recorded program reproduction”, a flag indicating “reproduction ended in master” is raised sequentially.

As described above, in accordance with the first embodiment, the two contents reception record reproduction apparatuses are connected to the network as a master and a slave such that when operations are performed in the master to receive and select a program to be viewed, record a received program, and reproduce a recorded program, as well as at the end of the respective operations, the master creates viewing information including the corresponding program name, the transmission station name, and the name of the current operating mode thereof, and transmits the created viewing information to the slave via the viewing information management server. Further, when the option for “viewing an identical program to the master” is selected in the slave using the input unit for selecting the program to be viewed, the slave receives and displays or receives and records a program having an identical station name to the program that is currently being received and displayed or received and recorded by the master, on the basis of the latest viewing information received from the master via the viewing information management server. Hence, the user of the master can view a broadcast program or a recorded program by performing a typical operation for selecting a program or recording and reproducing a program. Meanwhile, the user of the slave can view the same broadcast program or recorded program as the user of the master easily without performing any special operations other than selecting the option provided for selecting a received program. Further, the user of the slave can view a program recorded by the user of the master in the past easily without performing any operations other than selecting the option, and therefore the number of opportunities for the user of the slave to view a program after selecting the option can be maximized. Thus, when there are no programs that the user of the slave particularly wishes to view, the user of the slave can view the same program as the user of the master through a simple operation.

Note that a constitution in which only a program included in a broadcast wave received by the program reception unit 101 is used as a subject was described in the above example. However, a program from a network distribution service such as VoD (Video on Demand) or a program from a DLNA (Digital Living Network Alliance) guideline-compatible apparatus, for example, may be used as a subject.

Further, a combination of one master and one slave was described in the above example, but a similar control can be performed when a plurality of slaves are combined with a single master.

Furthermore, the viewing information management server 400 may be a server that provides a service other than the service described in the first embodiment, for example a service such as SNS (Social Networking Service), simultaneously.

### Second Embodiment

The constitution of a broadcast reception record reproduction apparatus in accordance with a second embodiment of the present invention is basically identical to the constitution of the broadcast reception record reproduction apparatus in accordance with the first embodiment, illustrated in FIG. 1. However, an apparatus control method employed by the control unit 107 differs from that of the first embodiment in a manner to be described below.

The viewing information transmitted to the server 400 by the master 100 is created by the control unit 107 and has a data configuration such as that shown in FIG. 9, for example. In FIGS. 9, 201 to 205 are identical to their counterparts in FIG. 2, and thus, descriptions thereof will be omitted. 901 is a reproduction time position set when the operating mode 205 of the master is “recorded program reproduction”.

Next, operations of the master 100 in accordance with the second embodiment will be described.

As described in the first embodiment, the master 100 is controlled by the control unit 107. However, the viewing information is transmitted at the timings when normal reproduction is resumed after completion of a special reproduction operation such as fast-forward, rewind, and pause, while viewing a recorded program on the master 100, in addition to the timings described in the first embodiment.

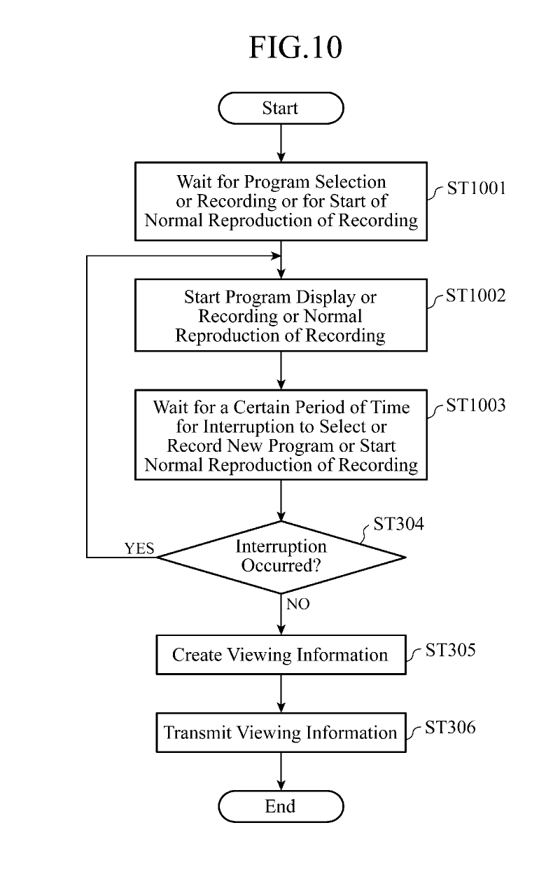

The transmission processing of the viewing information in the control unit 107 will now be described in accordance with a flowchart shown in FIG. 10. FIG. 10 corresponds to FIG. 3 in the first embodiment, and steps (step ST304 onward) having identical numbers to those in FIG. 3 indicate identical processing, and thus descriptions thereof will be omitted. First, a standby state is maintained for program selection, or recording start or start of normal reproduction of a recorded program (step ST1001). When the program selection, or the recording start or the start of normal reproduction of the recorded program arises, a corresponding operation is performed (step ST1002).

Thereafter, a standby state is maintained for a certain period of time while waiting for an interruption of a new program selection or record start or start of normal reproduction of the recorded program (step ST1003). As described in the first embodiment, this operation is performed to prevent the viewing information from being transmitted frequently within a short time period. Then, if the interruption for the new program selection or recording start arises within a certain period of time, the routine returns to step ST1002, and when the interruption does not occur, the routine advances to the following step ST305 (step ST304). Operations relating to subsequent steps are identical to those of the first embodiment, and descriptions thereof will be omitted.

The operations performed by the server 400 upon reception of the viewing information are identical to those of the first embodiment, and description thereof has been omitted. Further, the master 100 transmits viewing information in which “viewing ended” or “recording ended” is set (described in code) as the operating mode name. This operation is also similar to its counterpart in the first embodiment, and description thereof has been omitted.

Next, operations of the slave 200 will be described.

The operations of the slave 200 are basically identical to those of the first embodiment. However, a method of displaying a recorded program currently under reproduction in the master 100 differs from the first embodiment.

A recorded program currently under reproduced in the master 100 can be displayed when the operating mode name in the viewing information is “recorded program reproduction” and an identical program has already been recorded by the recording function of the slave 200. This point is identical to the first embodiment.

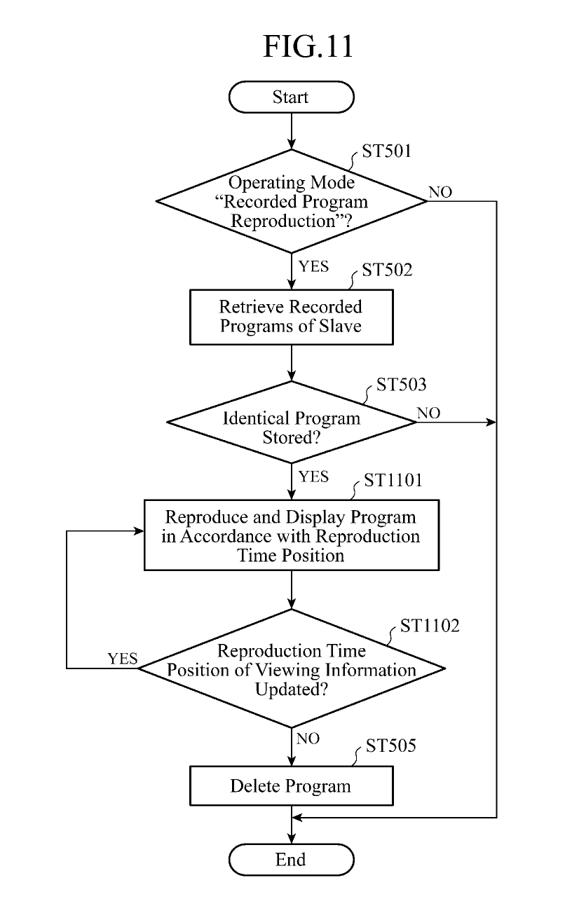

A processing flow executed by the control unit 107b at this time will now be described in accordance with FIG. 11. FIG. 11 corresponds to FIG. 5 of the first embodiment, and steps having identical numbers to the steps in FIG. 5 indicate identical processing. Operations relating to the steps step ST501 to ST503 are identical to the first embodiment, and therefore description thereof has been omitted.

When the determination of step ST503 is affirmative, the recorded contents of the program is reproduced and displayed on the display unit 102b (step ST1101). However, at this time, the reproduction time position included in the viewing information is checked, and reproduction is started from an identical reproduction time position. New viewing information is then received, and if the reproduction time position in the new viewing information has been updated (step ST1102), the routine returns to the step ST1101, in which program display is resumed from the updated reproduction time position. If the reproduction time position in the viewing information has not been updated, program display is continued, after which the program is deleted to avoid an event such that the same program is displayed a plurality of times (step ST505).

In accordance with the second embodiment described above, during reproduction of a recorded program, the master creates viewing information also including the reproduction time position and transmits the created viewing information to the slave via the viewing information management server; and the slave then displays an identical program to the program displayed by the master at an identical reproduction time position on the basis of the viewing information. Hence, in addition to the matters mentioned in the first embodiment, the user of the slave can view the same recorded program as the user of the master from an identical reproduction time position easily without performing any special operations other than selecting the option provided for selecting a received program. As a result, the user of the slave can view the same program as the user of the master from the same time position through a simple operation.

Note that in the second embodiment, similarly to the first embodiment, a program from VoD or a DLNA-compatible apparatus may be used as a subject. Further, a plurality of slaves maybe provided relative to one master.

### INDUSTRIAL APPLICABILITY

According to the contents reception record reproduction apparatus according to the present invention, the user of the master can view a broadcast or distributed program or a recorded program by performing a typical operation for selecting a program or recording and reproducing a program, while the user of the slave can view the same received program or recorded program as the user of the master easily without performing any special operations other than selecting the option provided for selecting a program to be viewed; thus, it is suitable for use in a program contents viewing system in which an identical program is individually obtained by two apparatuses but is simultaneously used in an identical operation mode, and a contents reception record reproduction apparatus for use in the system.

1. A program contents viewing system, in which
at least two contents reception record reproduction apparatuses having a function for receiving and displaying, receiving and recording, and reproducing a program obtained from a broadcast or a network distribution service are connected to and registered in a viewing information management server as a master and a slave via a network,
upon reception selecting a program to be viewed, upon recording a received program, and upon reproducing a recorded program, as well as at the end of each operation thereof, the master creates viewing information including a corresponding program name, a transmission station name, and a name of a current operating mode thereof, and transmits the created viewing information to the slave via the viewing information management server, and
when an option for “viewing an identical program to the master” provided in an input unit for selecting the program to be viewed is selected, the slave receives and displays or receives and records a program having an identical station name to a program that is currently being received and displayed or received and recorded in the master, on the basis of the latest viewing information of the master received from the viewing information management server.

2. The program contents viewing system according to claim 1, wherein when a program currently under view and record in the master is not currently under broadcast in an existing area of the slave but the program to be scheduled for broadcast in the future is determined from received EPG information, the slave stores this program by timer recording.

3. The program contents viewing system according to claim 1, wherein in the case that the option is selected in the slave by the input unit, when the master has reproduced the recorded program from the latest viewing information of the master, if an identical recorded program to the recorded program of the master is stored in the slave, the slave reproduces and displays the identical recorded program.

4. The program contents viewing system according to claim 1, wherein the master obtains the program name and the transmission station name described in the viewing information from EPG information.

5. The program contents viewing system according to claim 1, wherein the master creates the viewing information and transmits the created viewing information to the server only when a user of the master has viewed a single program for a certain period of time.

6. A contents reception record reproduction apparatus that has a function for receiving and displaying, receiving and recording, and reproducing a program obtained from a broadcast or a network distribution service, and that is connected to a viewing information management server via a network and registered therein as a master,
wherein upon reception selecting a program to be viewed, upon recording a received program, and upon reproducing a recorded program, as well as at the end of each operation thereof, viewing information including a corresponding program name, a transmission station name, and a name of a current operating mode of the master is created, and the created viewing information is transmitted to a contents reception record reproduction apparatus serving as a slave via the viewing information management server.

7. The contents reception record reproduction apparatus according to claim 6, wherein the program name and the transmission station name described in the viewing information are obtained from EPG information.

8. The contents reception record reproduction apparatus according to claim 6, wherein the viewing information is transmitted to the server only when a user of this apparatus has viewed a single program for a certain period of time.

9. A contents reception record reproduction apparatus that has a function for receiving and displaying, receiving and recording, and reproducing a program obtained from a broadcast or a network distribution service, and is connected to a viewing information management server via a network and registered therein as a slave,
wherein in the case that an option for “viewing an identical program to a master” provided in an input unit for selecting a program to be viewed is selected, a program having an identical station name to a program that is currently being received and displayed or received and recorded by the master is received and displayed or received and recorded, on the basis of the latest viewing information including a program name, a transmission station name, and a name of a current operating mode of the master, and created by the master and received from the viewing information management server.

10. The contents reception record reproduction apparatus according to claim 9, wherein when a program currently under view and record in the master is not currently under broadcast in an existing area of the slave but the program to be scheduled for broadcast in the future is determined from received EPG information, this program is stored by timer recording.

11. The contents reception record reproduction apparatus according to claim 9,
wherein in the case that the option is selected by the input unit, when the master has reproduced the recorded program from the latest viewing information of the master, if an identical recorded program to the recorded program of the master is stored, the identical recorded program is reproduced and displayed.

12. The program contents viewing system according to claim 3, wherein during reproduction of a recorded program, the master creates viewing information also including a current reproduction time position of the recorded program in the master and transmits the created viewing information to the slave periodically via the viewing information management server, and
when the slave reproduces and displays an identical recorded program to the recorded program of the master, the slave checks the reproduction time position, and reproduces and displays this identical recorded program at an identical reproduction time position to the master.

13. The contents reception record reproduction apparatus according to claim 6, wherein during reproduction of a recorded program, viewing information also including a reproduction time position of the recorded program is created and transmitted to the viewing information management server periodically.

14. The contents reception record reproduction apparatus according to claim 11, wherein when an identical recorded program to the recorded program of the master is reproduced and a reproduction time position of the master is included in the viewing information, reproduction is performed at an identical reproduction time position.
